(19) United States
(12) Patent Application Publication
(10) Pub. No.: US 2025/0363848 A1
(43) Pub. Date: Nov. 27, 2025

(54) SYSTEMS AND METHODS FOR FACILITATING MESSAGE EXCHANGE BETWEEN CITIZENS AND OFFICIALS

(71) Applicant: YazeMedia LLC, Rome, GA (US)

(72) Inventor: Collins Mkandawire, Rome, GA (US)

(73) Assignee: YazeMedia LLC, Rome, GA (US)

(21) Appl. No.: 19/286,973

(22) Filed: Jul. 31, 2025

Related U.S. Application Data
(63) Continuation-in-part of application No. 18/519,048, filed on Nov. 26, 2023.

(51) Int. Cl. G07C 13/00; H04L 51/066

(52) U.S. Cl. CPC G07C 13/00; H04L 51/066

(57) ABSTRACT

A message exchange platform including a memory and a processor is disclosed. The memory may store a machine learning model trained on a training dataset including historical message exchange between a plurality of users and a plurality of officials on the platform. The processor may obtain a message including a poll from an official, and analyze, via the machine learning model, the message relative to the historical message exchange between the users and officials on the platform. The processor may further identify, based on the analysis, at least one historical poll result or message exchange similar to the message obtained from the official, and selectively fetch and cache historical messages associated with the identified historical poll result or message exchange. The processor may further identify a user who is citizen of the geographical area associated with the official, and transmit the message and the historical messages to the user.

### CROSS-REFERENCE TO RELATED APPLICATION

The present application is a continuation-in-part application of U.S. application Ser. No. 18/519,048, filed Nov. 26, 2023, which is hereby incorporated by reference herein in its entirety.

### TECHNICAL FIELD

The present disclosure relates to a message exchange platform and more specifically to a message exchange platform that enables message exchange between citizens and elected representatives.

### BACKGROUND

In a democratic setup, citizens elect their representatives (or “officials”) for county, city, state, or nation. In many cases, communication between the citizens and the officials break after the officials are elected. In such cases, the citizens may feel neglected or feel that their voices/opinions are not heard or given due importance. Due to this lack of communication, the officials may take some decisions or propose some bills that may not be in the interest of the citizens or take decisions that the citizens may not like.

There exist social networking and microblogging websites that enable users to post their messages or opinions online, however, such platforms are open-to-all and hence anyone can post a message on any topic and address it to anyone. This makes communication on these conventional platforms cluttered, and it is not easy for citizens and officials to have targeted communication related to the geographical areas that they represent.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example process of signing-up on a message exchange platform in accordance with the present disclosure.

FIG. 3 depicts an example view of a user accessing a user device in accordance with the present disclosure.

FIG. 4 depicts a flow diagram of an example method for facilitating message exchange between a plurality of users and officials on a message exchange platform in accordance with the present disclosure.

### DETAILED DESCRIPTION

### Overview

The present disclosure describes a message exchange platform (“platform”) that enables citizens of a geographical area to post/transmit messages, comments, opinions, images, videos, etc. to elected representatives or officials of the geographical area. The term “message exchange platform” can be used interchangeably with the term “social media platform”, without departing from the scope of the present disclosure. In an exemplary aspect, the platform may not allow other users of the platform (who may not be citizens of the geographical area) to post to the officials. The other users may still view the messages posted to the officials, but they cannot themselves post the messages to the officials. In this manner, the officials receive messages on the platform only from the citizens of the official's geographical area, and hence only receive messages that are “relevant” to the officials, thereby removing clutter, noise or unimportant messages/opinions. In a similar manner, the officials can post messages on the platform containing information about one or more bills that the officials may desire to propose, polls on key issues, policies, and/or the like. The citizens of the official's geographical area may view these messages and share opinions, respond to poll, etc. on the platform. An example manner in which users and officials interact with each other on the platform is briefly described below.

During operation, when an official desires to conduct a poll on a predefined topic, the official may access the platform and post a message including the poll on the platform. The platform may analyze, via a machine learning model hosted on the platform, the message relative to historical message exchange between the users and the officials on the platform. The platform may further identify, based on the analysis described above, at least one historical poll result or message exchange similar to the message obtained from the official. Specifically, at this stage, the platform may identify historical message exchange between any of the users and the officials that may be on the same topic as the message obtained from the official.

Responsive to identifying the historical poll result or message exchange similar to the message obtained from the official, the platform may selectively fetch and cache historical messages associated with the identified historical poll result or message exchange. In addition or in parallel, the platform may identify one or more users who may be citizens of the geographical area associated with the official or the geographical area of which the official is an elected representative of. The platform may then transmit the message containing the poll obtained from the official, and the cached historical messages associated with the identified historical poll result or message exchange to the identified users. The historical messages may enable the users to optimally respond to the poll posted by the official.

In further aspects, the platform may enable the “citizen” users to respond to the poll posted by the official on the platform, but may not allow (or disable) other users (e.g., “non-citizen” users) from responding to the poll. The platform may further enable the citizen users to transmit or post messages to the official on the platform, but may not allow the non-citizen users to transmit any messages to the official, to prevent cluttering of the official's account or page with non-relevant posts or messages that are not from the citizens of the area from where the official is elected.

The platform may further implement one or more computing optimization methods to ensure smooth and fast message deliveries between the users and the officials via the platform. For example, the platform may compress the message (e.g., the message containing the poll posted by the official) using a custom protocol before transmitting the message to the users, to minimize network bandwidth consumption associated with the network connecting the platform to the user's computing devices. The platform may further compress the message based on device-specific constraints associated with the user's computing devices, e.g., an available memory, a display resolution, a battery status, and/or the like.

The platform may further enable the user to interact with representatives of companies, stores, schools, etc., which may be located in the same geographical area as the users, in the similar manner as described above. The platform may further enable the users to form groups, friends, digital communities, etc., similar to conventional social networking platforms, and post messages, images, videos, etc. on the groups. Stated another way, the platform can also operate as a normal social media platform where the citizens/users can form groups, post videos, advertise their merchandize, share direct messages (DMs), etc.

The present disclosure discloses a message exchange platform that enables citizens of a geographical area to post/transmit messages, comments, opinions, images, videos, etc. to elected representatives or officials of the geographical area. The platform prevents cluttering of the official's account or page on the platform, and only relevant messages from citizens are posted on the official's page. The platform further reduces platform-side computational latency by selectively fetching and cashing those historical messages that are likely to be most relevant to the users, before transmitting these messages to the users. Furthermore, the platform compresses the messages using a custom protocol before transmitting the messages to the user's computing devices, to minimize network bandwidth consumption associated with the network connecting the platform to the computing devices.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

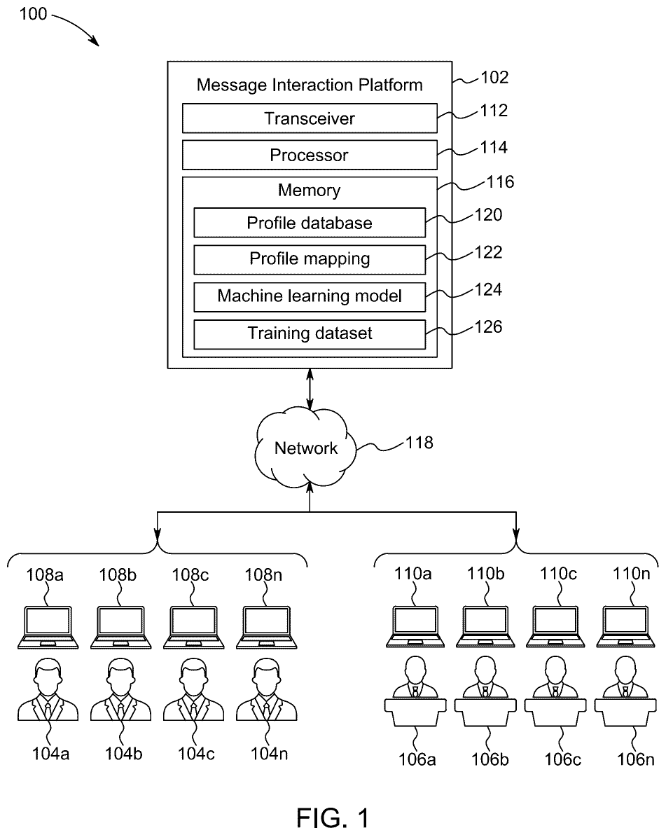

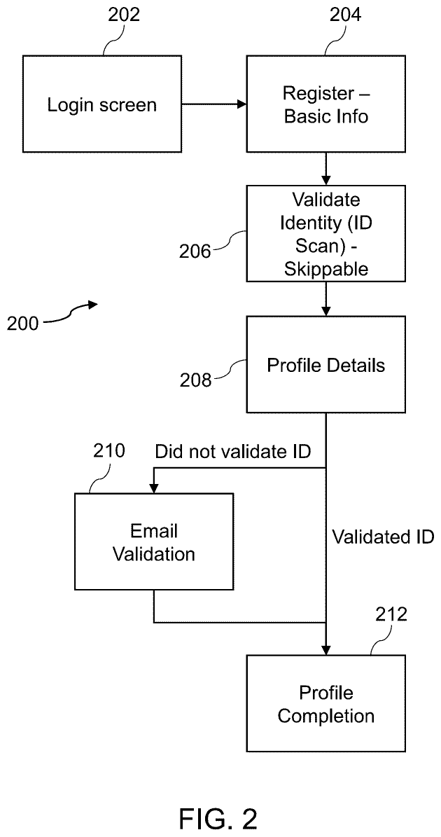

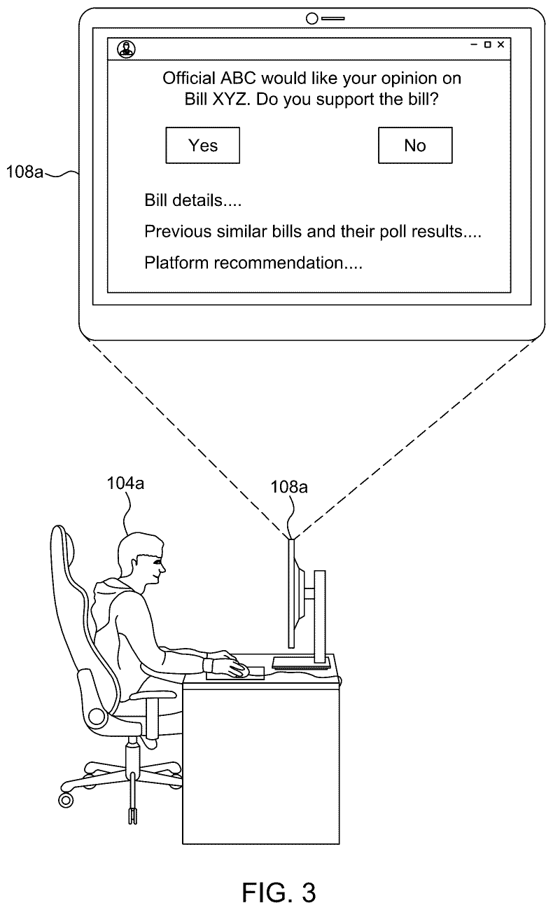

FIG. 1 depicts an example environment 100 in which techniques and structures for providing the systems and methods disclosed herein may be implemented. FIG. 1 will be described in conjunction with FIGS. 2 and 3.

The environment 100 may include a message interaction platform 102 (or platform 102) that may enable message exchange between a plurality of “citizens” or users 104a, 104b, 104c, 104n (collectively referred to as users 104) and a plurality of officials 106a, 106b, 106c, 106n (collectively referred to as officials 106). The users 104 may be associated with user devices 108a, 108b, 108c, 108n (collectively referred to as user devices 108), and the officials 106 may be associated with official devices 110a, 110b, 110c, 110n (collectively referred to as official devices 110). Each user 104 may access the platform 102 via the respective user device 108, and each official 106 may access the platform 102 via the respective official device 110. In some aspects, the user devices 108 may be similar to the official devices 110, and may be, for example, mobile phones, laptops, computers, smartwatches, or other similar devices with communication capabilities.

In one exemplary aspect, each official 106 may be an elected representative of a geographical area, which may be, for example, a county, a city, a state, or a country. For example, the official 106a may be Mayor of City A, the official 106b may be Governor of State B, the official 106c may be President of a Country C, and so on. In another exemplary aspect, each official 106 may be a representative of a company, a store, a school, and/or the like, associated with a specific geographical area (e.g., a specific county, city, state, etc.). The present disclosure is described in the context of each official 106 being an elected representative of a geographical area, however, such description should not be construed as limiting the scope of the present disclosure.

It is known that in a democratic setup, citizens elect their representatives (or “officials”) for county, city, state, or nation. It is known that in many cases, once the officials are elected, it is difficult for common citizens to reach to them, share their opinions, or generally be part of key decisions that the officials might take. For example, it is difficult for citizens to voice their opinions on local issues (e.g., infrastructure, education, taxes, economy, policies, etc.) that are specific to their geographical areas, or share their comments on key bills that the officials may be planning to pass. In a similar manner, it may be challenging for an official to seek opinions on key issues, bills, etc. from the citizens of the geographical area that the official represents. There exist conventional social networking and/or microblogging platforms that enable message exchange between a plurality of users, however, such conventional platforms are open-to-all, meaning anyone can post a message to anyone on any topic on these platforms. Consequently, on these platforms, an elected representative or official may receive hundreds or thousands of messages from users across the globe, and hence it may become difficult for the official to understand which messages are from the citizens of the geographical area that the official represents (and hence are more “relevant” messages) and which messages are from non-citizens.

The platform 102 addresses the challenges described above. Specifically, the platform 102 is a social networking or microblogging platform that enables citizens of a geographical area to post/transmit messages, comments, opinions, images, videos, etc. to the elected representative or official of the geographical area, and does not allow other users of the platform 102 (who may not be citizens of the geographical area) to post to the official. The other users may still view the messages posted to the official, but they cannot themselves post the messages to the official. In this manner, the official receives messages on the platform 102 only from the citizens of the official's geographical area, and hence only receives messages that are “relevant” to the official, thereby removing clutter, noise or unimportant messages/opinions. In a similar manner, the official can post messages on the platform 102 containing information about one or more bills that the official may desire to propose, polls on key issues, policies, and/or the like. The citizens of the official's geographical area may view these messages and share opinions, respond to poll, etc. In this case also, the other users (who may be non-citizens) may view the official's messages, but may not be able to respond to them (e.g., respond to the poll or voice their opinion). In this manner, the official may receive inputs/responses on key issues or polls only from the citizens of the geographical area, and not from non-citizens (whose opinions or responses to the polls may not be relevant to the official).

In some aspects, the platform 102 may be hosted on a server or a distributed computing system and may include a plurality of components including, but not limited to, a transceiver 112, a processor 114 and a memory 116. The transceiver 112 may receive/transmit data, information, signals, messages, etc. from/to one or more external systems and devices (e.g., the user and official devices 108, 110), via a network 118. The network 118 may be, for example, a communication infrastructure in which the connected devices discussed in various embodiments of this disclosure may communicate. The network 118 may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The memory 116 may store programs in code and/or store data for performing various platform operations in accordance with the present disclosure. Specifically, the processor 114 may be configured and/or programmed to execute computer-executable instructions stored in the memory 116 for performing various platform functions in accordance with the disclosure. Consequently, the memory 116 may be used for storing code and/or data code and/or data for performing operations in accordance with the present disclosure.

In one or more aspects, the processor 114 may be in communication with one or more memory devices (e.g., the memory 116 and/or one or more external databases (not shown in FIG. 1)). The memory 116 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 116 may be one example of a non-transitory computer-readable medium and may be used to store programs in code and/or to store data for performing various operations in accordance with the present disclosure. The instructions in the memory 116 may include one or more separate programs, each of which may include an ordered listing of computer-executable instructions for implementing logical functions.

In some aspects, the memory 116 may include a plurality of modules and databases including, but not limited to, a profile database 120, a profile mapping 122, a machine learning model 124, and a training dataset 126. The machine learning model 124 may be stored in the form of computer-executable instructions, and the processor 114 may be configured and/or programmed to execute the stored computer-executable instructions for performing platform functions in accordance with the present disclosure. The functions associated with the machine learning model 124 and the training dataset 126 may be understood in conjunction with the description provided below.

In some aspects, the platform 102 may be an Artificial Intelligence/Machine Learning (AI/ML) based platform that may identify patterns in messages posted on the platform 102 by the users 104 and the officials 106, and provide recommendations to the users 104 based on the identified patterns. The recommendations may be associated with suggested responses to opinion polls posted by the officials 106 or information from historical message exchange that may help the users 104 in making a well-informed decision while responding to the polls. A person ordinarily skilled in the art may appreciate that machine learning is an application of Artificial Intelligence (AI) using which systems or platforms (e.g., the platform 102) may have the ability to automatically learn and improve from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, content update, email filtering, medical diagnosis, pattern identification, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In the classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In the regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning but may not be trained using sample data. This model may learn “as it goes” by using trial and error. A sequence of successful outcomes may be reinforced to develop the best recommendation or policy for a given problem in reinforcement learning.

In an exemplary aspect, the platform 102 may use supervised machine learning to effectively identify patterns in the messages posted on the platform 102. Specifically, the machine learning model 124 may be trained on the training dataset 126, by using supervised machine learning. The training dataset 126 may include information associated with historical message exchange between the users 104 and the officials 106 on the platform 102. In an exemplary aspect, the machine learning model 124 may include a recurrent neural network (RNN) trained to identify patterns in the historical message exchange between the users 104 and the officials 106 on the platform 102. The “patterns”, as described herein, may mean identification of similar messages that may share similar themes, content types, topic, and/or the like. As an example, if a new message is posted on the topic of property tax in a specific geographical area, the machine learning model 124 may identify similar historical messages that may have been posted on the platform 102 in the past, which share the same topic (i.e., property tax).

In some aspects, the training dataset 126 may be built over time, as more and more users and officials access the platform 102 and post their messages. In other aspects, the platform 102 may fetch the training dataset 126 from a third-party server (not shown) that may provide such data. The training dataset 126 may be regularly updated, e.g., based on continuous interactions of the users 104 and the officials 106 on the platform 102. Consequently, the machine learning model 124 may be updated regularly (or “re-trained”) as and when the training dataset 126 is updated. In further aspects, the machine learning model 124 may be re-trained based on feedback of users using the platform 10 and/or the platform administrator's feedback.

In some aspects, the profile database 120 may store profiles of the users 104 and the officials 106. Each profile may include personally identifiable information including, but not limited to, name, address, contact information, social security number, license, gender, age, and/or the like. The platform 102/profile database 120 may receive such information from the users 104 and the officials 106 when they register on the platform 102 or create their account on the platform 102.

The profile mapping 122 may store a mapping of a profile of each official 106 (e.g., the official 106a) with the profiles of one or more users 104 (e.g., the users 104a, 104b) based on a geographical area associated with the official 106a. In this case, the users 104a, 104b may be citizens of the geographical area represented by the official 106a. As an example, if the official 106a is Mayor of City A, the users 104a, 104b may be citizens of City A. In this case, the profile mapping 122 may store a mapping that maps the profile of the official 106a with the profiles of the users 104a, 104b. Continuing with the same example, if the user 104c is not a citizen of City A, the profile mapping 122 may not map the profile of the user 104c with the profile of the official 106a. In this manner, the profile mapping 122 maps an elected representative of a geographical area with the citizens of that geographical area, and not to other users. In an exemplary aspect, the term “citizen” of a geographical area, as used in the present disclosure, may mean a user who has voting rights in the geographical area. In other aspects, a citizen may be a user who may be a resident of the geographical area, or a legal citizen not registered to vote (e.g., a citizen with an age of less than 18).

In operation, each user 104 and/or each official 106 may access, via their respective user device 108 and/or official device 110, a website or an application (“app”) associated with the platform 102 to register themselves or create an account for themselves. An example process for registering on the platform 102 is shown in FIG. 2 as a process 200, and described below.

At first step 202, the processor 114 may render a login screen associated with the platform 102 on the user device 108 (or the official device 110) associated with the user 104 (or the official 106). At step 204, the user 104 may register or enter, via the user device 108, basic information associated with the user 104 on the login screen. The basic information may be, for example, the user's name. Thereafter, at an optional or skippable step 206, the user 104 may upload, via the user device 108, the user's ID (e.g., license) on the login screen and the processor 114 may scan and validate the ID.

If the user 104 uploads the ID on the login screen at the step 206, the processor 114 may automatically extract the user's profile details from the ID and fill them in the login screen at step 208. If the user 104 does not upload the ID on the login screen at the step 206, the processor 114 may output a prompt requesting the user 104 to manually enter the user's profile details on the login screen. Responsive to viewing the prompt, the user 104 may enter the user's profile details on the login screen at the step 208. The profile details may include personally identifiable information such as, the user's address (of the area the user 104 is citizen of), contact information, age, gender, etc. In some aspects, the process 200 may include an additional step 210 of email validation (to be performed by the user 104) if the ID is not validated. The profile creation is completed at step 212 after the user 104 performs the email validation or after the user's ID is validated.

Responsive to the user's profile being created, the processor 114 may update the mapping stored in the profile mapping 122. Specifically, the processor 114 may map the profile of the user 104 with the profile of the official 106 who may be the elected representative of the geographical area mentioned in the user's profile. For example, if the user's profile indicates that the user 104 is a citizen of or has voting rights of City A, the processor 114 may search for the elected representative/official 106 of City A, and map the profile of the user 104 with the profile of the official 106 in the profile mapping 122.

In some aspects, before updating the mapping, the processor 114 may first authenticate the user 104 and validate the user's address or geographical area (e.g., City A) that the user 104 claims to be a citizen of in the user's profile. In an exemplary aspect, the processor 114 may authenticate the user 104 and validate that the user 104 has voting rights of City A based on the personally identifiable information that the user 104 has entered on the login screen. In further aspects, the processor 114 may authenticate the user 104 and validate that the user 104 has voting rights of City A based on an Internet Protocol (IP) address of the user device 108 used by the user 104 to access the platform 102. As an example, if the user device's IP address indicates that the user 104 is located in City B and the user 104 claims to be resident/citizen of City A in the user's profile, the processor 114 may not validate the user's profile/address and may instead request for more information from the user 104 to validate the user's credentials. On the other hand, if the user device's IP address indicates that the user 104 is located at City A, the processor 114 may validate the user's profile/address. The processor 114 may then update the profile mapping 122 based on the user's address, responsive to validating the user's profile/address. In some aspects, the processor 114 may obtain the user device's IP address via the transceiver 112, by using any known methods of obtaining IP addresses.

Once the user's profile is validated, the user 104 may access the platform 102 to view the messages posted by other users and officials 106 on the platform 102, and may post own messages to the official 106 who is the elected representative of the geographical area the user 104 is a citizen of. In a similar manner as described above, the officials 106 may create their profiles or accounts on the platform 102 and start to access the platform 102 to post messages, polls, etc. In one exemplary aspect, the officials 106 may not be required to themselves create their profiles or accounts, but the platform 102 may itself create accounts for their offices (e.g., offices of Members of Congress, Senators, and Governments (Federal, State, and Local)). For example, the platform 102 may itself create an account or profile for “Mayor of City A”, and whosoever is the Mayor of City A at that time may access and use this profile to post messages, polls, etc. An example way in which the users 104 and the officials 106 can use the platform 102, after their profiles/accounts are created, is described below.

In an exemplary aspect, when an official (e.g., the official 106a) desires to conduct a poll on a predefined topic, the official 106a may access, via the official device 110a, the platform 102 and post a message including the poll on the official's “page” (which may be a dedicated digital space associated with the official's account) on the platform 102. The predefined topic may be, for example, a new bill that the official 106a may propose related to property tax, education system, new infrastructure, new taxation policy, economy, and/or the like.

The processor 114 may obtain, via the transceiver 112, this message including the poll from the official device 110a. The processor 114 may then analyze, via the machine learning model 124, the message relative to the historical message exchange between the users 104 and the officials 106 on the platform 102 (or relative to the training dataset 126). The processor 114 may further identify, based on the analysis described above, at least one historical poll result or message exchange similar to the message obtained from the official 106a/official device 110a. Specifically, at this stage, the processor 114 may identify historical message exchange between any of the users 104 and the officials 106 that may be on the same topic as the message obtained from the official 106a. For example, if the message obtained from the official 106a is associated with a poll for a new bill that the official 106a desires to propose that may increase the property tax by 5%, the processor 114 may identify, based on the analysis performed via the machine learning model 124, historical polls conducted on the platform 102 or historical message exchange between the users 104 and the officials 106 that may also be associated with increasing the property tax.

Responsive to identifying the historical poll result or message exchange similar to the message obtained from the official 106a, the processor 114 may selectively fetch (from the memory 116) and cache historical messages associated with the identified historical poll result or message exchange. It may be appreciated that selectively fetching and caching these historical messages reduce platform-side computational latency by selectively fetching and cashing those historical messages that are likely to be most relevant to users (as opposed to fetching a large amount of messages, not all of which may be relevant to the users).

In addition or in parallel, the processor 114 may identify, based on the mapping stored in the profile mapping 122, one or more users (e.g., the users 104a, 104b) who may be citizens of the geographical area associated with the official 106a or the geographical area of which the official 106a is an elected representative of. The processor 114 may then transmit, via the transceiver 112, the message containing the poll obtained from the official 106a, and the cached historical messages associated with the identified historical poll result or message exchange, to the user devices 108a, 108b associated with the users 104a, 104b. The historical messages may enable the users 104a, 104b to optimally respond to the poll posted by the official 106a. For example, if the official 106a desires to take the user's opinion on whether the property tax should be raised by 5%, the historical messages may provide an indication to the users 104a, 104b on how other users have historically responded to such polls involving property tax increase, what has been the generic public mood after the property tax was increased in other geographical areas, and/or the like. Based on such historical messages, the users 104a, 104b may respond to the poll posted by the official 106a. In certain aspects, the processor 114 may additionally identify (via the machine learning model 124 and the historical messages) a recommendation for the users 104a, 104b on how best to respond to the poll, and may then transmit the recommendation to the user devices 108a, 108b. An example view of a user interface of the user device 108a, depicting the information described above, is shown in FIG. 3.

In some aspects, the processor 114 may enable the user 104a, 104b to respond, via the user devices 108a, 108b, to the poll posted by the official 106a on the platform 102, but may not allow (or disable) other users (e.g., the user 104c, who may not be a citizen of the geographical area associated with the official 106a) from responding to the poll. For example, the user 104a, 104b may respond a “Yes” or “No” to the poll, but the user 104c cannot respond to the poll. In this manner, the official 106a may view or receive results of the poll based only on the responses provided by the citizens (and not by non-citizens), thereby considerably reducing clutter in the inbox/page/account associated with the official 106a on the platform 102. In some aspects, the user 104c may still view (on the user device 108c) the message posted by the official 106a including the poll on the platform 102, but may not be able to respond to the poll.

The processor 114 may further transmit real-time poll results associated with the poll posted by the official 106a to the user devices 108a, 108b. The processor 114 may additionally update the real-time poll results based on the responses to the poll obtained from the users 104a, 104b/user devices 108a, 108b, and may transmit the updated real-time poll results to the user devices 108a, 108b. In this case as well, the user 104c may be able to view (on the user device 108c) the real-time poll results associated with the poll posted by the official 106a, but may not be able to comment or post a message on the results.

The processor 114 may additionally enable the users 104a, 104b (i.e., the “citizens”) to transmit, via the user devices 108a, 108b, a message (associated with, e.g., a response to the poll, a query, a general concern, raise an issue, etc.) to the official 106a on the platform 102. The official 106a may view the message and respond to it on the platform 102. Similar to the aspect described above, the processor 114 may not allow the user 104c (i.e., a “non-citizen”) to transmit any messages to the official 106a, to prevent cluttering of the official's account or page with non-relevant posts or messages that are not from citizens of the area from where the official 106a is elected.

The processor 114 may further implement one or more computing optimization methods to ensure smooth and fast message deliveries between the user/official devices 108, 110 via the platform 102. For example, the processor 114 may compress the message (e.g., the message containing the poll posted by the official 106a) using a custom protocol before transmitting the message to the user devices 108a, 108b, to minimize network bandwidth consumption associated with the network 118 connecting the platform 102 to the user devices 108a, 108b. The custom protocol may be, for example, transform coding protocol (like Discrete Cosine Transform (DCT) and Discrete Wavelet Transform (DWT)), entropy coding protocol (like Huffman coding), and/or the like. In further aspects, the processor 114 may obtain information associated with device-specific constraints from the user devices 108a, 108b, and may compress the message based on the device-specific constraints. The device-specific constraints may be, for example, an available memory, a display resolution, or a battery status of the user device 108a, 108b. As an example, the processor 114 may highly compress the message when the battery status of the user device 108a, 108b indicates a very low state of charge. In this case, high compression may reduce the size of the message, and may thus facilitate the user device 108a, 108b to receive the message without substantial use of battery power.

The description above describes an aspect where the users and the elected representatives exchange messages amongst themselves on the platform 102; however, the present disclosure is not limited to such an aspect. The platform 102 may be similarly used by the users to post messages and receive responses from representatives of companies, stores, schools, etc., which may be located in the same geographical area as the users. These messages may be related to commerce, company policies (e.g., return policies on selected items from a convenience store), education system, condition of infrastructure, and/or the like. Various news outlets, survey firms, etc. can also use the platform 102 to conduct their own polls. In some aspects, the platform 102 can be used by corporations, organizations, churches, schools, colleges, and all groups of citizens/users with a grouping email address or websites as participants. Such entities can also partition their representative(s) on the platform 102.

The platform 102 may further enable the users to form groups, friends, digital communities, etc., similar to conventional social networking platforms. A group admin can add or remove users from the group, and the users may post their messages on the group's page/account, similar to how messages are posted on conventional social networking platforms. In some aspects, these groups may be restricted to citizens of specific geographical areas, so that the messages are relevant to the citizens and cluttering can be avoided.

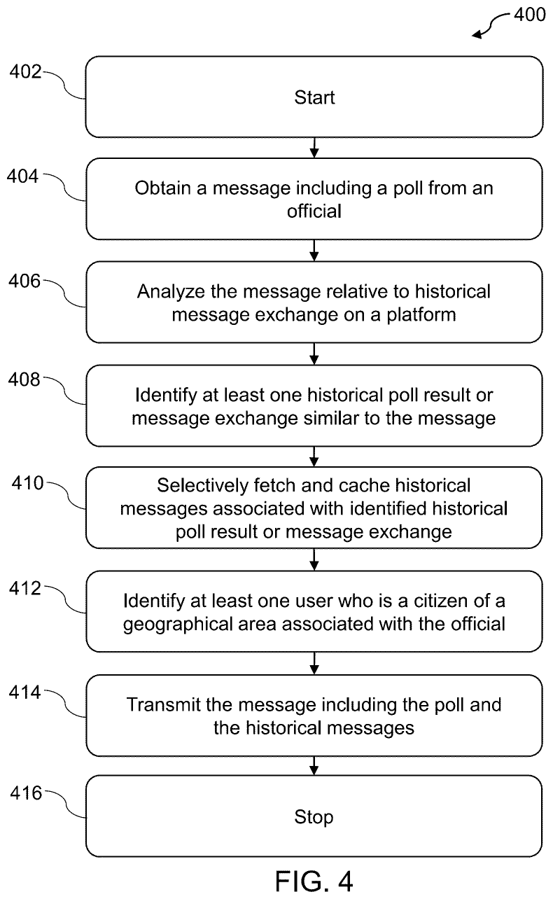

FIG. 4 depicts a flow diagram of an example method 400 for facilitating message exchange between the users 104 and the officials 106 on the platform 102 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the processor 114, a message including a poll on a predefined topic from an official (e.g., the official 106a). At step 406, the method 400 may include analyzing, by the processor 114 via the machine learning model 124, the message relative to historical message exchange between the users 104 and the officials 106 on the platform 102.

At step 408, the method 400 may include identifying, by the processor 114 based on the analysis, at least one historical poll result or message exchange similar to the message obtained from the official 106a. At step 410, the method 400 may include selectively fetching and caching, by the processor 114, historical messages associated with the identified historical poll result or message exchange. In some aspects, selectively fetching and caching the historical messages reduce platform-side computational latency by selectively fetching and cashing those historical messages that are likely to be most relevant to users.

At step 412, the method 400 may include identifying, by the processor 114, at least one user (e.g., the users 104a, 104b), who may be citizens of the geographical area associated with the official 106a, based on the mapping stored in the profile mapping 122. At step 414, the method 400 may include transmitting, by the processor 114, to the user devices 108a, 108b, the message including the poll and the historical messages to enable the users 104a, 104b to optimally respond to the poll.

At step 416, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A platform comprising:
a memory configured to store:
profiles of a plurality of users and a plurality of officials;
a mapping of a profile of each official with profiles of one or more users based on a geographical area associated with each official, wherein the one or more users are citizens of the geographical area; and
a machine learning model trained on a training dataset comprising information associated with historical message exchange between the plurality of users and the plurality of officials on the platform; and
a processor configured to:
obtain a message comprising a poll on a predefined topic from a first official of the plurality of officials;
analyze, via the machine learning model, the message relative to the historical message exchange between the plurality of users and the plurality of officials on the platform;
identify, based on the analysis, at least one historical poll result or message exchange similar to the message obtained from the first official;
selectively fetch, from the memory, and cache first historical messages associated with the at least one historical poll result or message exchange, wherein selectively fetching and caching the first historical messages reduce platform-side computational latency by selectively fetching and cashing those historical messages that are likely to be most relevant to users;
identify, based on the mapping, at least one user, of the plurality of users, who is a citizen of the geographical area associated with the first official; and
transmit, to a user device associated with the at least one user, the message comprising the poll, and the first historical messages to enable the at least one user to optimally respond to the poll.

2. The platform of claim 1, wherein the one or more users have voting rights in the geographical area.

3. The platform of claim 2, wherein the processor is further configured to:
obtain personally identifiable information associated with the plurality of users; and
authenticate the one or more users and confirm that the one or more users have voting rights in the geographical area based on the personally identifiable information associated with the one or more users.

4. The platform of claim 3, wherein the processor is further configured to confirm that the one or more users have voting rights in the geographical area based on IP addresses of user devices used by the one or more users to access the platform.

5. The platform of claim 3, wherein the personally identifiable information comprises at least one of: a name, an address, a contact information, a social security number, a license, a gender, or an age.

6. The platform of claim 1, wherein the each official is an elected representative of the geographical area.

7. The platform of claim 1, wherein the geographical area is a county, a city, a state, or a country.

8. The platform of claim 1, wherein the processor is further configured to transmit real-time poll results associated with the poll to the user device associated with the at least one user.

9. The platform of claim 8, wherein the processor is further configured to:
enable the at least one user to respond to the poll via the user device; and
disable other users, from the plurality of users, who are not citizens of the geographical area from responding to the poll.

10. The platform of claim 9, wherein the processor is further configured to:
update the real-time poll results based on a response obtained from the at least one user; and
transmit updated real-time poll results to the user device associated with the at least one user.

11. The platform of claim 9, wherein the processor is further configured to enable the other users to view the message comprising the poll and the real-time poll results on user devices associated with the other users.

12. The platform of claim 1, wherein the processor is further configured to enable the at least one user to transmit, via the user device associated with the at least one user, a response message or a query message to the first official on the platform.

13. The platform of claim 1, wherein the processor is further configured to compress the message using a custom protocol before transmitting the message to the user device, to minimize network bandwidth consumption associated with a network connecting the platform to the user device.

14. The platform of claim 13, wherein the processor is further configured to:
obtain information associated with device-specific constraints from the user device; and
compress the message based on device-specific constraints, wherein the device-specific constraints comprise at least one of: an available memory, a display resolution, or a battery status of the user device.

15. The platform of claim 1, wherein the machine learning model comprises a recurrent neural network (RNN) trained to identify patterns in the historical message exchange between the plurality of users and the plurality of officials on the platform.

16. A method comprising:
obtaining, by a processor, a message comprising a poll on a predefined topic from a first official of a plurality of officials;
analyzing, by the processor via a machine learning model, the message relative to historical message exchange between a plurality of users and the plurality of officials on a platform, wherein the machine learning model is trained on a training dataset comprising information associated with the historical message exchange between the plurality of users and the plurality of officials on the platform;
identifying, by the processor based on the analysis, at least one historical poll result or message exchange similar to the message obtained from the first official;
selectively fetching and caching, by the processor, first historical messages associated with the at least one historical poll result or message exchange, wherein selectively fetching and caching the first historical messages reduce platform-side computational latency by selectively fetching and cashing those historical messages that are likely to be most relevant to users;
identifying, by the processor, at least one user, of the plurality of users, who is a citizen of a geographical area associated with the first official based on a mapping of a profile of each official with profiles of one or more users based on the geographical area associated with each official, wherein the one or more users are citizens of the geographical area; and
transmitting, by the processor, to a user device associated with the at least one user, the message comprising the poll, and the first historical messages to enable the at least one user to optimally respond to the poll.

17. The method of claim 16 further comprising transmitting real-time poll results associated with the poll to the user device associated with the at least one user.

18. The method of claim 17 further comprising:
enabling the at least one user to respond to the poll via the user device; and
disabling other users, from the plurality of users, who are not citizens of the geographical area from responding to the poll.

19. The method of claim 16 further comprising compressing the message using a custom protocol before transmitting the message to the user device, to minimize network bandwidth consumption associated with a network connecting the platform to the user device.

20. A non-transitory computer-readable storage medium in a distributed computing system, the non-transitory computer-readable storage medium having instructions stored thereupon which, when executed by a processor, cause the processor to:
obtain a message comprising a poll on a predefined topic from a first official of a plurality of officials;
analyze, via a machine learning model, the message relative to historical message exchange between a plurality of users and the plurality of officials on a platform, wherein the machine learning model is trained on a training dataset comprising information associated with the historical message exchange between the plurality of users and the plurality of officials on the platform;
identify, based on the analysis, at least one historical poll result or message exchange similar to the message obtained from the first official;
selectively fetch and cache first historical messages associated with the at least one historical poll result or message exchange, wherein selectively fetching and caching the first historical messages reduce platform-side computational latency by selectively fetching and cashing those historical messages that are likely to be most relevant to users;
identify at least one user, of the plurality of users, who is a citizen of a geographical area associated with the first official based on a mapping of a profile of each official with profiles of one or more users based on the geographical area associated with each official, wherein the one or more users are citizens of the geographical area; and
transmit, to a user device associated with the at least one user, the message comprising the poll, and the first historical messages to enable the at least one user to optimally respond to the poll.
